(19) United States
(12) Patent Application Publication
(10) Pub. No.: US 2005/0115680 A1
(43) Pub. Date: Jun. 2, 2005

(54) Labelling device

(76) Inventors: Graham Edward Thoms, Londonderry (AU); Robert John Moran, Narrabeen (AU); Jean-Mark Yves Orhan, Mona Vale (AU)

Correspondence Address: 3M INNOVATIVE PROPERTIES COMPANY, PO BOX 33427, ST. PAUL, MN, 55133-3427, US

(21) Appl. No.: 10/511,281

(22) PCT Filed: Mar. 12, 2003
(86) PCT No.: PCT/US03/07438

(30) Foreign Application Priority Data
Apr. 12, 2002 (AU) PS1716

(51) Int. Cl. B32B 31/00

(52) U.S. Cl. 156/354; 156/521

(57) ABSTRACT

The present invention relates to a device for creating adhesive labels (51,52) from a web (2) of material having an adhesive side and a non-adhesive side. The device includes a web transport system (1) for transporting the web from a web source along a web path to a web path end, and a label transport system (16) for transporting a generated label along a label path.

### BACKGROUND OF THE INVENTION

The present invention relates to a device for creating adhesive labels from a web of material having an adhesive side and a non-adhesive side.

### DESCRIPTION OF THE PRIOR ART

The reference to any prior art in this specification is not, and should not be taken as, an acknowledgement or any form of suggestion that the prior art forms part of the common general knowledge in Australia.

A number of different designs of machine are provided for applying labels to boxes, or the like.

The labels may be formed in a number of different ways, the most popular of which include providing the label on a non-adhesive liner, and forming the label by severing a web of adhesive material.

In the former case, the adhesive side of the label is in contact with the non-adhesive liner, so that the liner and label combination have no adhesive surfaces. This makes the labels far easier to handle, in particular because the adhesive sides of the label have little chance of adhering to surfaces within the labelling machine.

An example of such a machine is shown in U.S. Pat. No. 5,549,783. In this case, pre-cut labels provided on a liner are stripped from the liner at a strip point, before being applied to the boxes further downstream. This allows for minor manipulation of the labels prior to application to the boxes, whilst still allowing the labels to be retained on the liner for as long as possible.

However machines of this form suffer from a number of drawbacks. In particular, the use of a liner on the labels wastes material, thereby making the labels more expensive. Furthermore, in this case, the labels are of a pre-cut size, and accordingly, a different set of labels will be required each time different sized labels are to be applied to boxes.

In contrast to this, machines using labels created from an adhesive web do not usually suffer from such drawbacks. In this case, the web itself is formed into labels by simply cutting the web to the desired size. This allows varying sizes of label to be created from a common web. Furthermore, the lack of an additional liner layer helps reduce the cost of the labels.

In general, machines of this form operate by printing information directly onto the web, and then cutting the web in appropriate position to form the labels. The labels are then transported to and applied to the boxes, or the like as required.

However, one problem of such an arrangement is that the web must be cut at some stage within the labelling machine. In general this will result the creation of a free end of the web, which is notoriously difficult to handle successfully. This is primarily because the cutting process can result in bending or other deformation of the web, which in turn causes the web to adhere either to itself, or other components in the machine. This can in turn cause the labelling machine to jam or become damaged. Similarly, the created label can similarly adhere to surfaces within the machine causing similar problems.

One proposed solution to this is shown in WO 98/42578. In this example, an application unit is brought into a grasping position to grasp the free end of the web where the web was cut to form the previous label. This is achieved by having the application unit coupled to a vacuum source, allowing the application unit to grasp the non-adhesive side of the web. The application unit is then used to draw the web out, allowing the web to be cut to create the new label, which can then be applied as required.

However, this design has a number of drawbacks. Firstly, as the web is cut, this again leaves a free end of the web in the machine that it not attached to anything, thereby increasing the risk of the web adhering to a surface within the machine. Secondly, the application unit would typically only have a limited range of movement, thereby limiting the versatility of the machine.

U.S. Pat. No. 2,492,908 describes an alternative solution to the problem of handling adhesive webs. In this example, a transfer head is used to retain labels whilst they are transferred from a pick-up station to an application station. However, in this example, the machine is adapted to operate with thermoactivatable adhesives, which do not have an adhesive effect until the adhesive is heated. Accordingly, when the label is picked-up, this must be achieved using a vacuum generated within the transfer head, which also allows the label to be easily released by deactivating the vacuum. It will therefore be appreciated that in this instance the machine does not have the problems of the labels sticking to internal components within the machine, primarily because the labels are not sticky until heat has been applied to the adhesive.

### SUMMARY OF THE PRESENT INVENTION

In a first broad form the present invention provides a device for creating adhesive labels from a web of material having an adhesive side and a non-adhesive side, the device including:
a) A web transport system for transporting the web from a web source along a web path to a web path end;
b) A label transport system for transporting a generated label along a label path;
c) A cutter positioned between the web path end and the label path, the cutter being adapted to cut the web to thereby generate the label;
d) A moveable holding member adapted to selectively hold the web by engaging the adhesive side of the web thereby causing the web to stick to the holding member in use; and,
e) A control system adapted to generate a label by:
   i) Causing the holding member to:
      (1) Engage the web provided at the web path end;
      (2) Move from the web path end to the label path, thereby causing the web to extend from the web path to the label path;
      (3) Release the web; and,
   ii) Cause the cutter to cut the web extending from the web path end to the label path to generate the label.
      Typically, once the web has been released, the control system is further adapted to:
(1) Move from the label path to the web path end; and,
(2) Hold the web provided at the web path end whilst the cutter cuts the web.

The web transport is preferably adapted to transport the web at a selected web speed. Similarly, the label transport is also preferably adapted to transport the labels at a selected label speed.

The control system is typically adapted to select the label speed and the web speed.

In this case, the control system is generally adapted to:
a) Select a web speed of zero when the web is being cut, or when the holding member is urged against the web;
b) Select a label speed greater than zero when the web is being cut; and,
c) Select the label speed to be greater than the web speed.

The control system also typically causes the holding member to:
a) Move at the selected web speed to move the web from the web path end to the label path; and,
b) Move at a speed greater than the selected web speed to release the web.

The holding member may be formed from a selectively rotatable roller, in which case, the control system being adapted to:
a) Prevent rotation of the roller when the web is being held and moved; and,
b) Allow rotation of the roller when the web is being released.

The web transport can be formed from a number of rollers around which the web is entrained in use, at least one of the rollers being coupled to a drive motor to allow the web to be driven at the selected web speed.

The label transport typically includes an endless belt system adapted to receive the non-adhesive side of the web. However, other systems such as rollers may be used:

The endless belt system preferably includes a number of apertures extending therethrough, the label transport further including urging means for urging air through the apertures to thereby urge the label against the endless belt system.

The device typically further includes a printing system for printing information on the labels, the printing system being positioned on the web path. The printing system may be a thermal transfer printing system, however other printing systems such as laser or ink jet printers may be used.

The applicator generally includes an endless applicator belt system adapted to receive the non-adhesive side of the label in use, the applicator belt system being movable to allow the adhesive side of the label to be urged against the article, in use.

The applicator belt system usually including a number of apertures extending therethrough, the applicator further including a vacuum pump coupled by a flow path to the apertures, the vacuum pump being adapted to generate a vacuum thereby urging the label against the endless belt system.

### BRIEF DESCRIPTION OF THE DRAWINGS

An example of the present invention will now be described with reference to the accompanying drawings, in which:

FIG. 1 is a schematic plan diagram of an example of a system for implementing the present invention;

FIG. 2 is a schematic side view of the label transport and applicator of FIG. 1;

FIG. 3 is a schematic diagram of an example of a control system for the system of FIG. 1;

FIGS. 4 to 14 are schematic diagrams showing the process of applying a label using the apparatus FIG. 1;

FIG. 15 is a schematic diagram of a processing system used for controlling the printing system of FIG. 1;

FIG. 16 is a schematic diagram of an alternative holding member for use in the system of FIG. 1;

FIG. 17 is a schematic plan view of an alternative applicator for use in the system of FIG. 1;

FIG. 18 is a schematic side view of an alternative applicator for use in the system of FIG. 1; and,

FIG. 19 is a view of a specific embodiment of the system of FIG. 1.

### DETAILED DESCRIPTION OF THE PREFERRED EMBODIMENTS

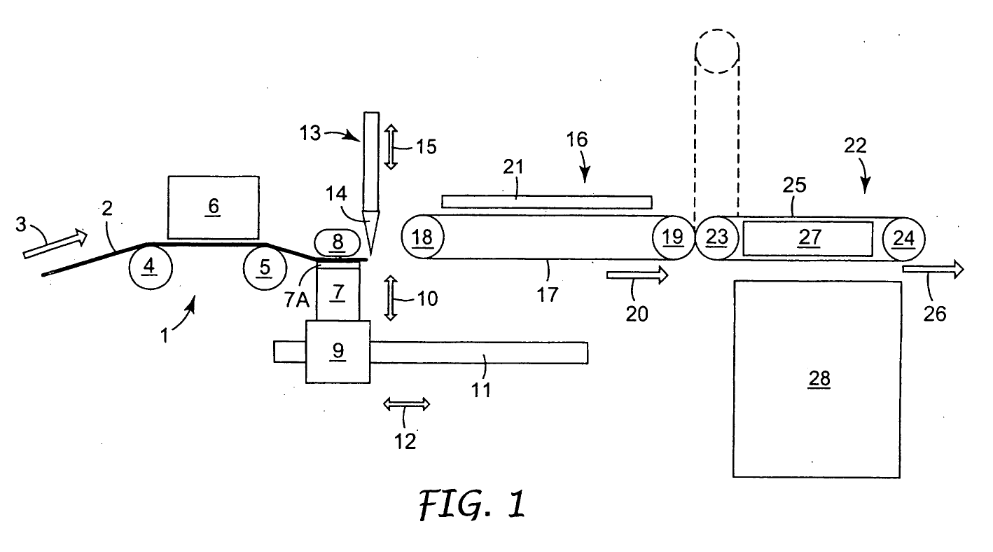

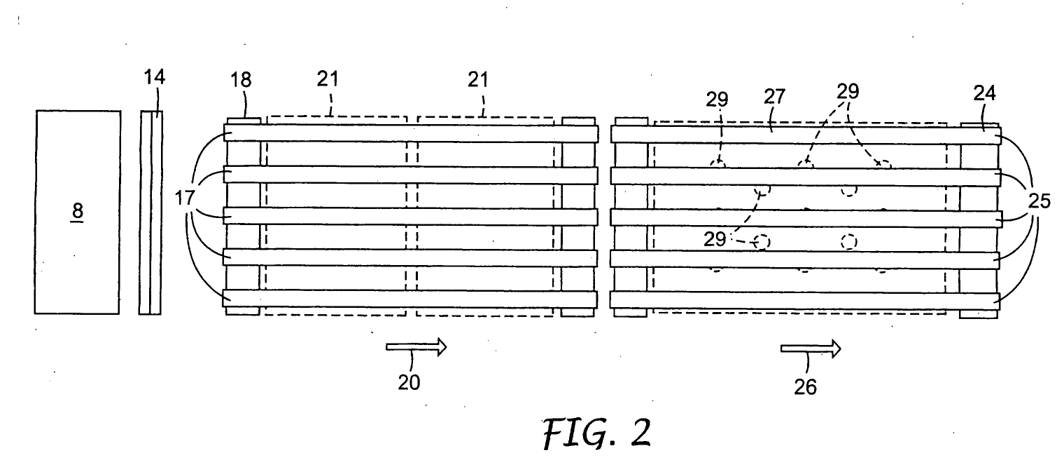

An example of labelling apparatus according to the invention will now be described with reference to FIGS. 1 and 2.

As shown, the labelling apparatus includes a web transport, shown generally at 1, that is adapted to transport a web 2 of adhesive material in the direction of arrow 3. The web transport will generally include a number of rollers or the like adapted to transport the web from a web source, such as a reel (not shown). In this example, only two rollers 4, 5 are shown for clarity. In use a drive motor will be drive one or more of the rollers in the web transport, as will be explained in more detail below.

A printing system 6 is optionally provided along the transport path defined by the web transport, to allow information to be printed on the labels. The adhesive web is arranged with the adhesive side of the web in contact with the rollers 4,5, and the non-adhesive side facing the printing system 6. This allows the non-adhesive side to be printed, as will be described in more detail below.

At the end of the web transport, a holding member 7 and a ski 8 are provided. The holding member includes a holding member plate 7A for contacting the web 2, and is moveably mounted to a carriage 9, to allow the holding member to be moved in the directions of the arrow 10. In addition to this, the carriage 9 is moveably mounted to a guide 11, to allow the holding member to be moved in the directions of arrow 12.

Positioned adjacent to the ski 8 is a cutter 13, having a blade 14. The cutter is moveably mounted to a support (not shown), to allow the cutter to move in the directions of the arrow 15.

Positioned downstream of the cutter is a label transport shown generally at 16. The label transport may have any one of a number of configurations. However, in this example, the label transport is formed from a number of endless belts 17 entrained around two rollers 18 19, as shown in FIG. 2. One or both of the rollers are driven by a drive motor to cause the endless belts 17 to move in the direction shown by arrow 20. In addition to the belts, a number of fans 21 are also provided, as will be described in more detail below.

Positioned downstream of the label transport is an applicator 22. In this example, the applicator 22 is formed from a number of endless belts 23, entrained around the rollers 24, 25, to allow the belts to move in the direction shown by the arrow 26, again as shown in FIG. 2. Again, this is achieved by driving one of the rollers 24, 25 using an associated drive motor. The applicator also includes a shoe 27 positioned within the endless belts 25. The shoe includes a number of apertures 29 that are coupled to a vacuum source, as will be explained in more detail below.

In use, the applicator is used to apply labels to articles, such as a box shown at 28.

In order to achieve this the applicator is progressively moveable between the position shown in FIG. 1, and the position shown in dotted lines. Again this is achieved using a drive motor.

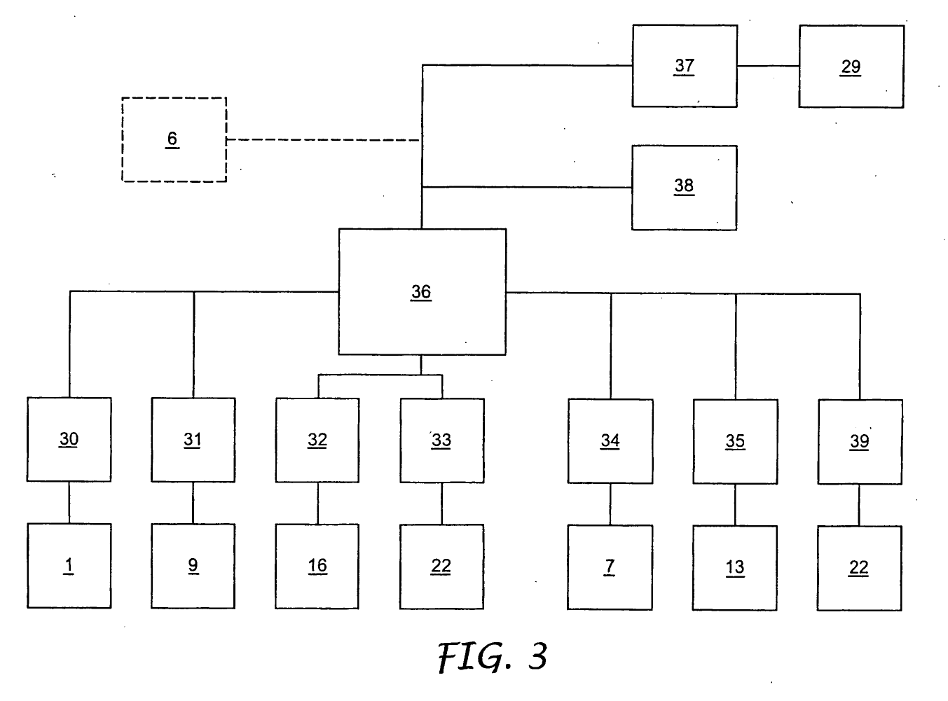

The configuration of the control system will now be described with reference to FIG. 3.

As shown in FIG. 3 the control system includes four drive motors 30, 31, 32, 33, which are coupled respectively to the web transport 1, the carriage 9, the label transport 16, and the applicator 22. Two actuators 34, 35 are provided, with each being coupled to a respective one of the holding member 7 and the cutter 13. Each of the drive motors 30, 31, 32, 33 and the actuators 34, 35 are coupled to a controller 36. This allows the controller 36 to operate the web transport I, the holding member 7, the carriage 9, the cutter 13, the label transport 16 and the applicator 22.

In addition to this the controller may be coupled to the printing system 6. In this case, the controller may be formed from a suitably programmed processing system, such as a computer, or the like. Alternatively, the printing system may be coupled to an alternative processor to allow the printing of information on labels to be controlled. In this case, the controller 36 may be formed from specific control hardware, as will be appreciated by persons skilled in the art.

The controller is also coupled to a vacuum pump 37, which is coupled to the apertures 29, a transport system 38, which is used to move the boxes 28, and an actuator 39, which is used to control the position of the applicator 22. The operation of these elements will be described in more detail below.

The manner of operation will now be described with reference to FIG. 1 and FIGS. 4 to 14, which show a complete cycle for applying a label to the box 28.

As shown in FIG. 1 the machine is initially configured with the web 2 extending through the web transport to the holding member 7 and the ski 8. If information is to be printed on the label, this occurs as the web passes through the printing system 6. It will be apparent from the subsequent description that this occurs as the previous label is created.

In any event, as the system allows the next label to be printed with tailored information, this allows the label to be printed in accordance with the information concerning the box 28, or other article to which the label is to be applied. In order to achieve this, the printing system 6 is coupled to a processing system that is able to generate information regarding the label to be printed. It will be appreciated that in this example, the processing system is the controller 36, although separate processing systems may be used.

This may therefore be achieved by having an operator manually enter information. Alternatively information may be obtained automatically from other processing systems. Thus for example, if the box contains packed food produce, the processing system may be adapted to receive weight or quality control information from other processing systems involved in the provision of the packed boxes 28 to the labelling apparatus.

This allows detection systems positioned upstream of the labelling apparatus to detect properties of interest regarding the respective boxes, and then transfer this information to the print system 6, via the controller 36, or other respective processing system, as required. The information is then printed on the label and applied to the respective box 28, as will now be described.

As a further point, the printing system may be formed from any one of a number of different types of printing system. Thus for example, the printing system may be formed from an ink or laser jet printer. Alternatively, a thermal transfer printing system may be used, as will be described in more detail below.

In any event, with the system in the position shown in FIG. 1, the controller 36 operates to urge the holding member 7 against the ski 8. At this point, the holding member plate 7A engages the adhesive side of the web, causing the web to stick to the holding member plate 7A.

In use the holding member plate 7A is typically formed from stainless steel or the like. This is preferable as it helps ensure that the machinery does not corrode, in particular because the labels are often applied to food products and it is therefore desirable that no corrosion such as rust or the like can be transferred to the label from the holding member 7.

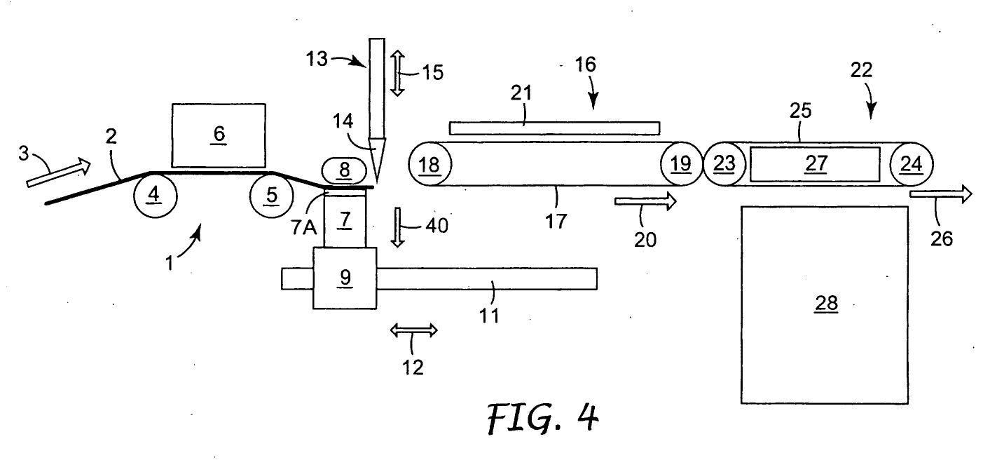

Once the holding member 7 has been urged towards the ski 8 such that the web adheres to the holding member plate 7A, then the controller 36 operates the actuator 34 to retract the holding member 7 away from the ski 8. This is shown in FIG. 4 by the arrow 40. In this case, with the web 2 adhered to the holding member plate 7A, then this causes the web to be withdrawn from the ski 8 as shown.

The next stage is for the controller 36 to activate the drive motors 30, 31 and 32.

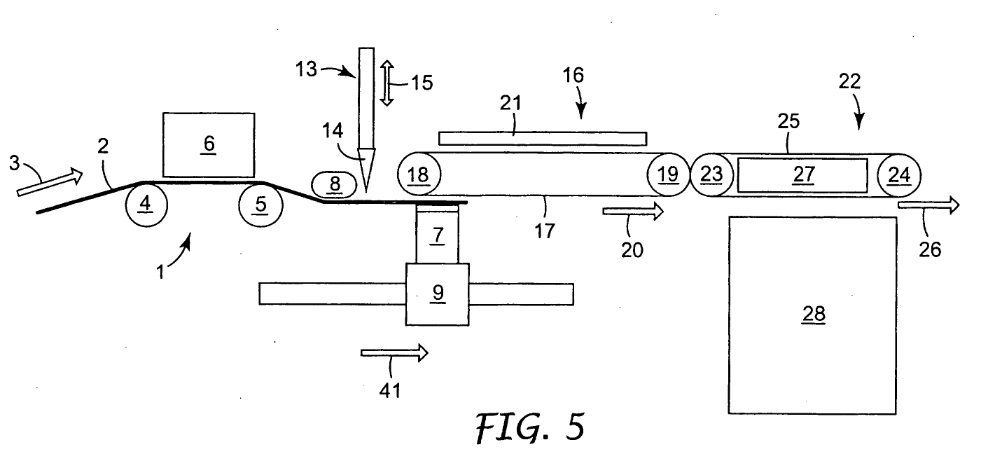

This is performed so that the web passes through the web transport 1 to the position shown in FIG. 5. In order to achieve this, it is important that the web is not unduly stretched or otherwise deformed. Accordingly, the drive motors 30, 31 are operated so that the linear velocity of the carriage 9 is identical to the velocity of the web 2 through the web transport 1. This helps ensure that the web remains substantially straight and under slight tension as shown in FIG. 5. It will be appreciated that it is particularly important that the carriage travels at least at the same speed as the web as otherwise, this could cause folding of the web between the roller 5 and the holding member 7.

When the web extends from the ski 8 to the label transport 16, the controller 36 operates to separate the holding member 7 from the web 2. This may be achieved in a number of ways depending on the implementation of the invention. However, in this example, this is achieved by increasing the speed of the drive motor 31 to cause a corresponding increase in the rate of transport of the carriage 9 in the direction of the arrow 41.

As a result of this, this generates a shear force between the holding member plate 7A and the web 2. The controller 26 ensures that the difference in velocities between the web 2 and the holding member 7 is sufficient to strip the web 2 from the holding member plate 7A.

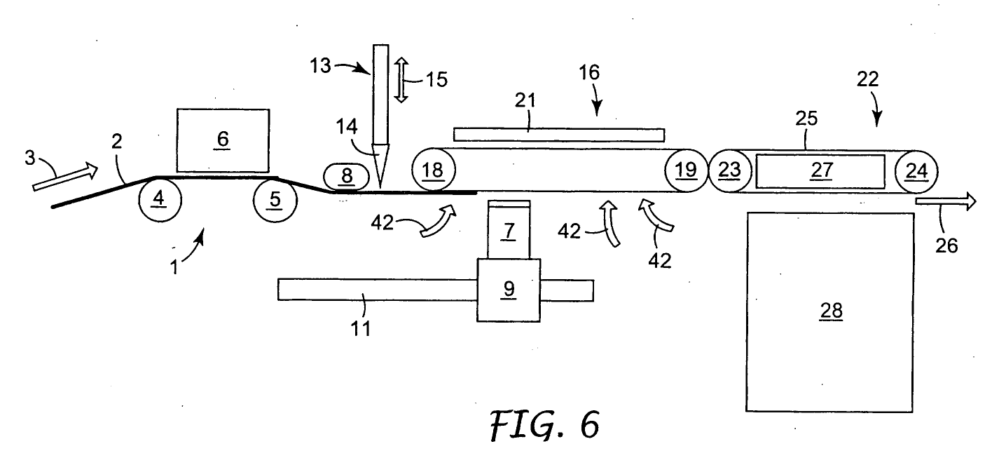

At this point, as shown in FIG. 6, the web 2 extends into the region of the label transport 16. The fans 21 operate to draw air through the belts 17, as shown by the arrows 42. This urges the web 2 against the endless belts 17 as shown in FIG. 6. It will be appreciates that at this stage, the non-adhesive side of the web is contacted with the endless belts 17 such that only the action of the air being drawn through the endless belts 17 will hold the web 3 in place.

It is important that the web 2 does not become deformed between the web transport 1 and the label transport 16. Accordingly, the controller 36 controls the operation of the drive motor 32 to ensure that the endless belts 17 are moving at a velocity slightly higher than that of the web transport 1. This ensures that the web 2 is under slight tension at this stage.

In fact, at this point it is generally desired to prevent further web 2 being fed through the web transport 1 and accordingly, the web transport 1 is normally stopped by the controller 36 at this time. However, this may depend on the length of label that is desired. Accordingly, it is possible to continue to feed the web through the web transport 1 and the label transport 16 at this time.

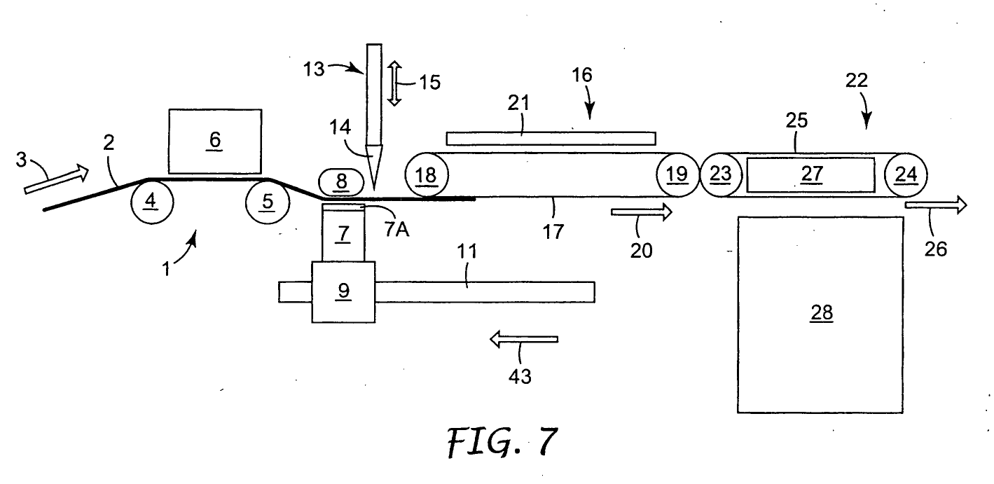

In any event, As shown in FIG. 7, the controller 36 then operates the drive motor 31 causing the carriage 9 to move in the direction shown by the arrow 43. Once the carriage 9 is realigned with the ski 8, the controller 36 will halt the drive motor 31 causing the carriage 9 to stop. The controller 36 will then operate the actuator 34 causing the holding member 7 to be urged against the ski 8, in the direction of arrow 44, thereby causing the web to adhere to the holding member plate 7A. In order to ensure that the web 2 does not become entangled in the web transport 1 it is important that the controller 36 has also halted operation of the web transport 1 before the holding member plate 7A contacts the web 2.

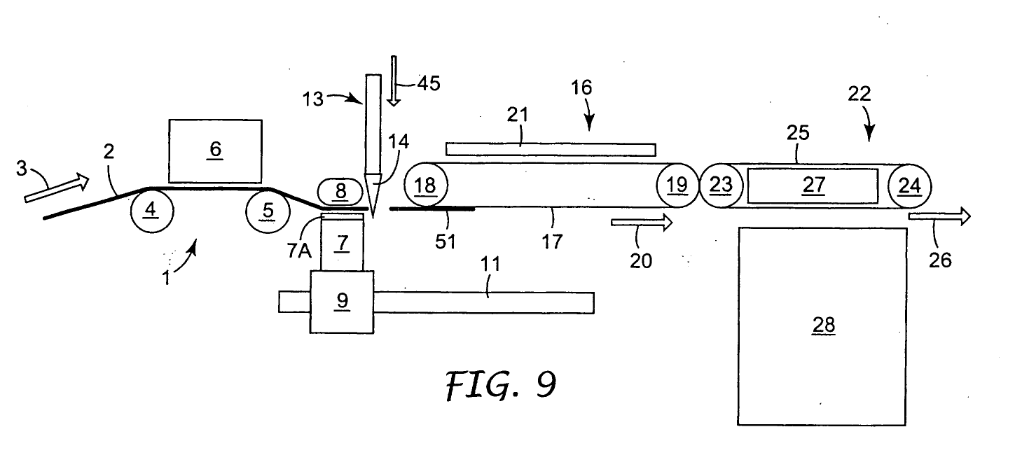

As shown in FIG. 9, the next stage is for the controller 36 to operate the actuator thereby causing the cutter 13 to move in the direction shown by the arrow 45. This causes the cutter blade 14 to slice through the web, to thereby create a label 51.

In order to ensure that a clean cut is obtained and in order to prevent the web from becoming entangled with the blade 14, the label transport 16 remains active during this process. This will create tension within the web 2 helping to ensure that the blade 14 can cut the web in a suitable manner. Furthermore, as the cutting is performed, this will ensure that the newly created label, shown generally at 51, is moved away from the end of the web, thereby ensuring that the label 51 and the web 2 do not adhere to each other.

It will be appreciated that different types of a cutter 13 may be used and for example instead of using a simple blade, a hot wire arrangement or the like could alternatively be used. Furthermore, in the case of simple blades, it is also possible to have co-operating blades on either side of the web 2.

In any event, at this stage the newly created label 51 moves in the direction of the arrow 20, as shown.

Operation of the labelling system at this point will depend on how the labels are to be applied to an article. Thus for example, if a single label is to be applied to an article the label 41 may be transferred directly to the applicator 22 before any further labels are created.

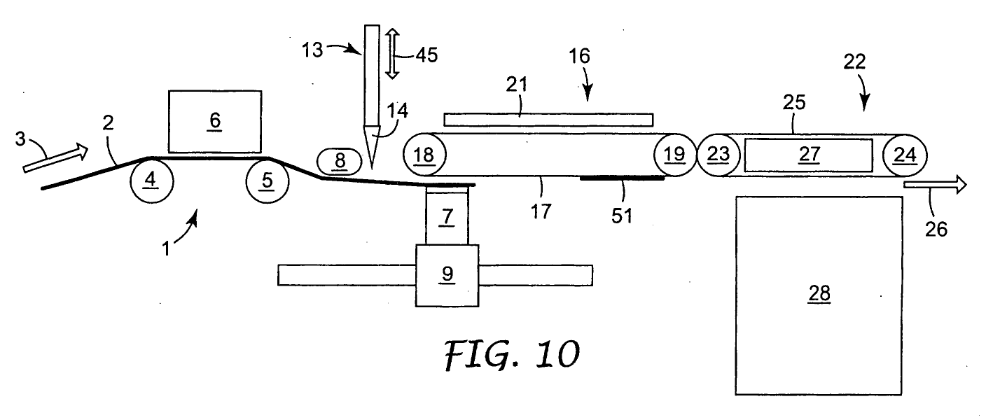

However, in this example, two labels are to be applied to the box 28. Accordingly, the system follows the same procedure to create a second and subsequent label. This is shown in FIG. 10. During this process, the first label is retained on the labelling transport 16. This therefore requires careful operation of the controller to ensure that the label 51 remains on the table transport without interfering with the newly created label.

Accordingly, in order to ensure this, the label transport 16 must be operated at a slightly higher velocity than the web transport 1. This ensures that the label 51 clears the end of the web 2 that is attached to the holding plate member 7A before the web 2 reaches the label transport 16.

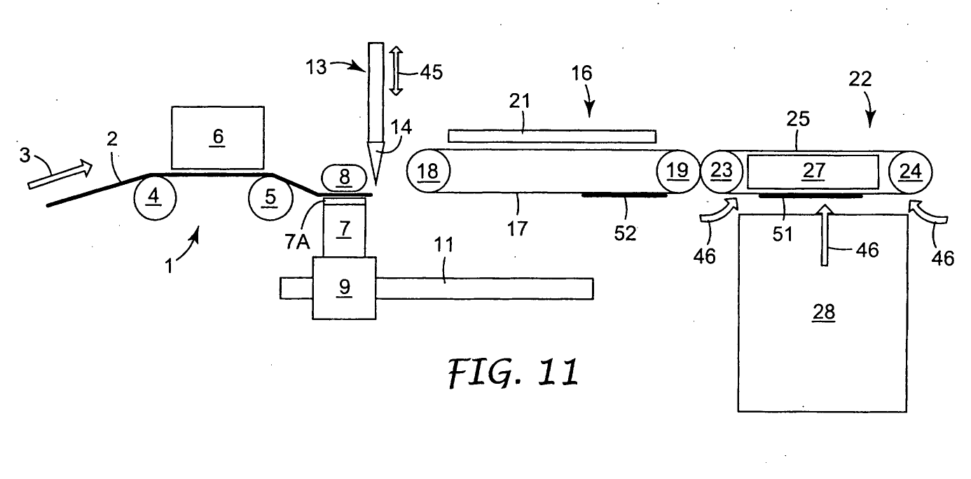

In any event, as the second label 52 is created, the first label 51 is transferred to the applicator 22, as shown in FIG. 11. In order to ensure this is achieved smoothly, the controller 36 operates the drive motors 33, 34 such that the endless belts 17, 25 are moving at identical velocities.

During this process, the controller 36 will also operate the vacuum pump 37, which operates to generate a vacuum within the shoe 27, thereby drawing air in through the apertures 29, as shown by the arrows 46. This in turn ensures that the label 51 is urged against the endless belts 25 to retain the label in place.

In the remainder of the description, the system will operate to apply the generated labels 51, 52 to the box 28. During this process, the remainder of the system may continue to generate the labels required for a subsequent box, with the labels being effectively held on the label transport until required. However, for the purpose of clarity, it will be assumed that no further labels are created at this time. Accordingly, the apparatus not used in actually physically applying the created to the boxes 28 is shown in dotted lines and will not be referred to further for the description of applying labels to the boxes.

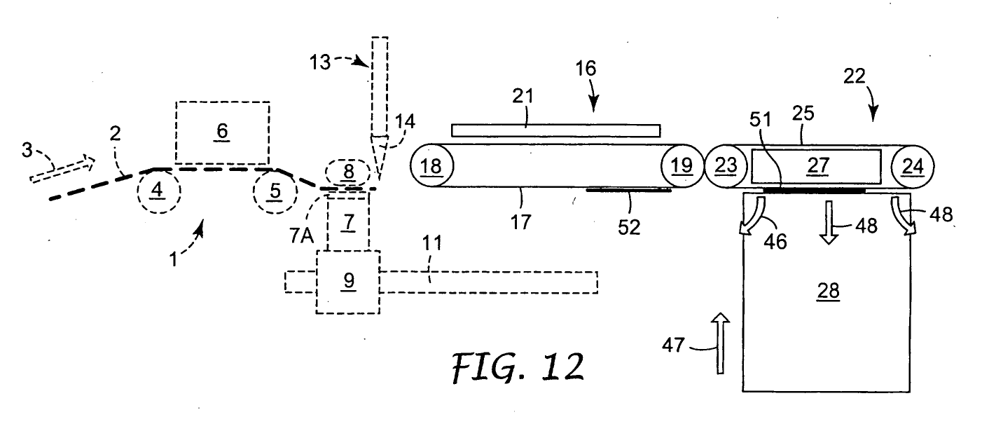

In any event, the box 28 is then moved into engagement with the label 51 as shown in FIG. 12. This is generally achieved by having the box positioned on the transport system 38. The transport system may be formed from a conveyor belt or the like, and is adapted to transport the box 28 in the direction of the arrow 47.

Accordingly, it will be appreciated that using the controller 36 to control the transport system 38 ensures synchronisation between the positioning of the boxes 28 and the applicator 22. In order to achieve this, it may be necessary to have sensors coupled to the controller 36 to allow the position of the boxes 28 to be determined.

In any event, as the box 28 moves into engagement with the label 51, the controller 36 will deactivate the vacuum applied to the shoe 27. Preferably this is achieved by releasing a control valve, or reversing the action of the vacuum pump 37 to cause air under pressure to be forced out of the apertures 29. This in turn will cause air to be urged against the label 51 as shown for example by the arrows 48, which will cause the label 51 to be urged against the box 28 as shown.

In addition to this, the shoe 27, which generally fits almost flush with the belts 25, will also act as a substantially flat surface to ensure that the label is evenly applied to the box 28, and does not become creased, or the like.

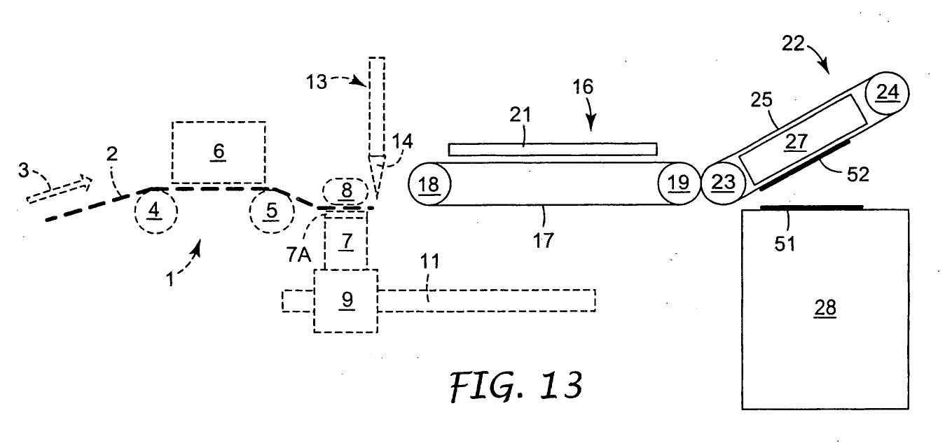

Once the first label 51 has been applied to the box as shown in FIG. 12, the controller 36 will cause the applicator 22 to be moved to the position shown in FIG. 13. This allows the second label 52 to be transferred to the applicator 22 without hitting the box 28. However, as an alternative the applicator may remain in the position shown for example in FIG. 12 with the box 28 being moved away from the applicator to allow the second label 42 to be transferred to the applicator.

In any event, the transfer of the label 52 to the actuator is typically achieved by having the controller 36 operate the actuator 39 allowing the position of the applicator 22 to be controlled. The controller 36 will also activate the drive motors 33, 34 causing the second label to be moved from the label transport 16 to the applicator 22. Simultaneously, the vacuum pump 37 is activated to draw air into the shoe 27, to thereby retain the label in place.

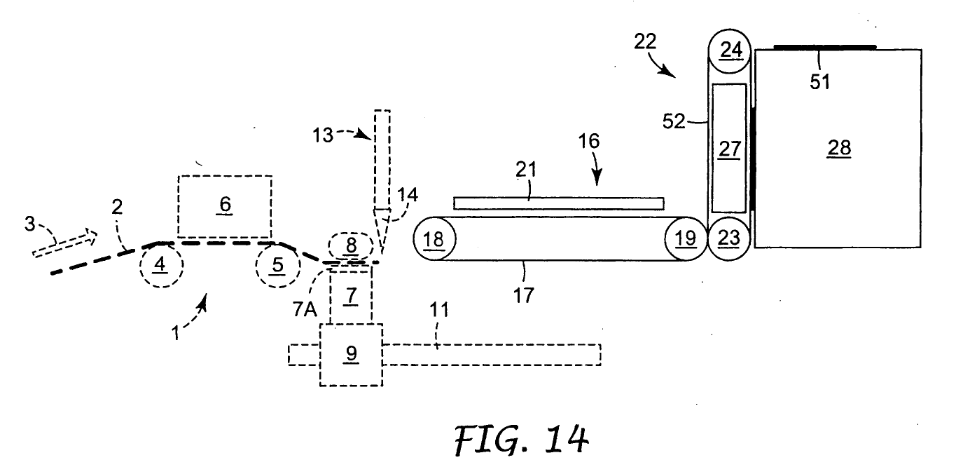

As shown in FIG. 14, the controller 36 then operates to move the applicator 22 to allow the label 42 to be applied to the side of the box 28. In order to achieve this, the box 28 is moved forward using the transport system 38 until it is positioned adjacent to the label 42. The controller 36 then operates the vacuum pump 38 to again cause air to be expelled through the shoe 27, causing the label to be urged against the box 28, as shown.

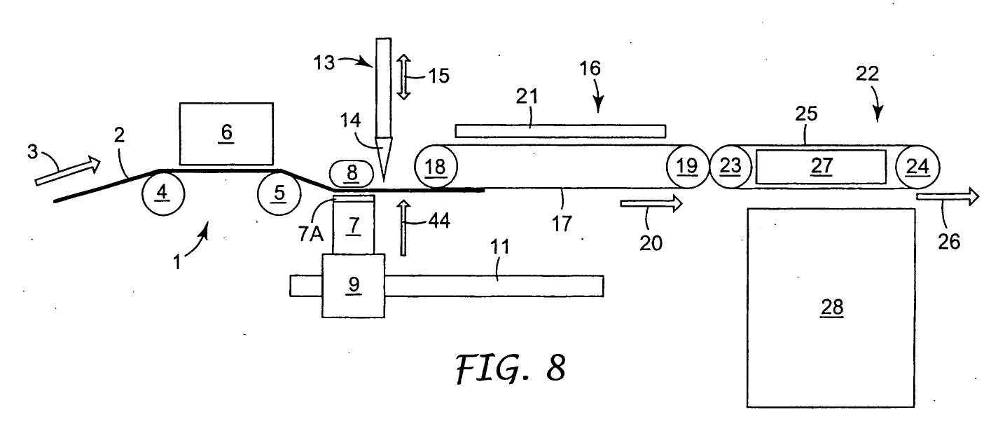

It will therefore be appreciated from the above, that the “free end” of the web, generated when the web is cut to form a label, is held under control at all times. In particular, when the “free end” of the web is created, the web is held by the holding member 7 to ensure the “free end” is retained under control of the holding member, as shown in FIGS. 8 and 9.

The web is then drawn out under control of the holding member 7, as shown in FIGS. 1, 4 and 5. At this point, the holding member releases control of the “free end” of the web. However, the web is urged toward the label transport 16, under the action of the airflow shown by arrows 42. As a result, the “free end” of the web is now controlled by the label transport. This allows the holding member to return to the position shown in FIG. 8, to grasp the web before a new “free end” is created.

As the “free end” of the web is under complete control at all times, this ensures that the “free end” is unable to move around and potentially adhere either to other web portions or other surfaces within the machine.

An additional benefit of the system shown in FIG. 1 is that the arrangement allows labels to be printed and created immediately before they are applied to an article such as a box. This allows labels to be created on a box by box basis, such that each label can include information reflecting the contents of the box. As mentioned above, this can include information such as the date and time of creation, the contents, the weight, or the like.

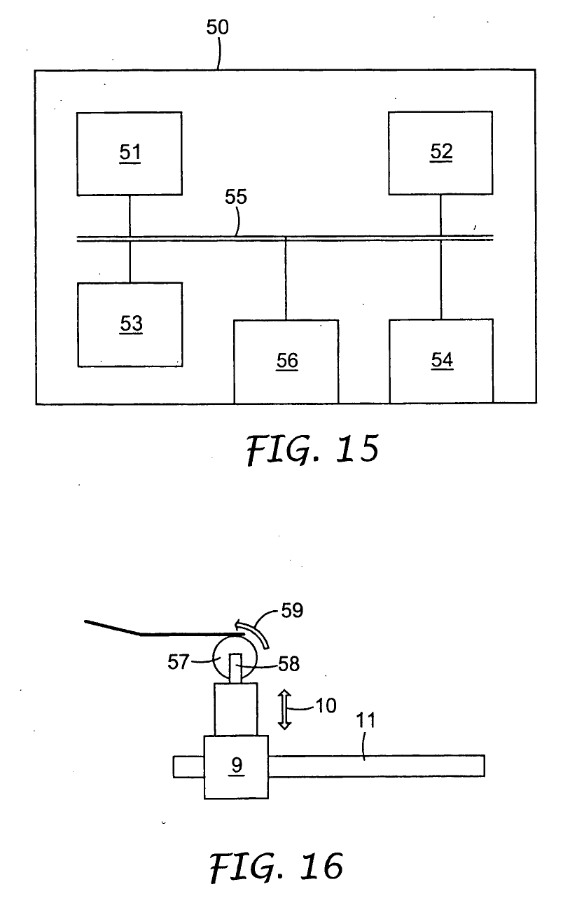

In order to achieve this, the controller is adapted to be coupled to other processing systems, such as via a communications network, such as a LAN, or the like. This allows the controller to obtain the required information that will typically be based on a predetermined template, or the like. Accordingly, in order to achieve this aspect of the operation, the controller 36 will typically include a processing system, an example of which is shown in FIG. 15.

As shown, the processing system 50 includes a processor 51, a memory 52, an input/output (I/O) device 53 and an interface 54 coupled together via a bus 55. In addition to this, the processing system also generally includes an interface 56, for coupling the processing system 50 to the printing system 6. The interface 53, which may be a network interface card, or the like, is used to couple the processing system 50 to a communications system (not shown), to allow the processing system to obtain information from other processing systems.

It will therefore be appreciated that the processing system 50 may be formed from any suitable processing system, which is capable of operating appropriate applications software to control the printing system 6. Accordingly, the processing system 50 may be formed from a server, such as a network server, web-server, or the like.

In any event, the processing system 50 will generally include a number of templates stored in the memory 52, defining the information to be included on respective label types. The operator can therefore select a desired label type, using the I/O device 53. The processor 51, then determines the information required for this label type from the template stored in the memory 52. The processor 51 then obtains the information via the communications network, before transferring the information to the printing system in a predetermined format.

By allowing the information to be obtained automatically in this manner, this allows the printing system 6 to print a label for a respective box immediately before the label is received. This in turn, allows the system to label the next box 28 to be received with a tailored label, in a manner known as next label out printing.

A number of modifications to the system can also be implemented to help system operation.

Once such modification is shown for example in FIG. 16. In this example a roller shown generally at 57 replaces the holding member plate 7A. The roller 57 is coupled to the holding member 7 via a clutch mechanism shown generally at 58. The clutch mechanism is an electronically controlled clutch that is coupled to the controller 36 to allow the controller to control rotation of the roller 57.

This allows for easier separation of the roller and the web 2, as will now be explained.

In use, the web 2 is adhered to the roller 57 by urging the roller toward the ski 8, as described above with respect to the holding member plate 7A. The web 2 can then be transferred to the label transport 16 by moving the carriage 9 as described above. During this process the roller 57 is maintained stationary by the clutch 58 so that it cannot rotate.

However, once the web 2 has reached the desired position on the label transport 16, the clutch 58 is activated to allow the roller 57 to rotate. As a result, when the carriage 9 is moving faster than the web 2 this will cause the roller 57 to rotate in direction of the arrow 59. As the roller 57 rotates this will cause the web 2 to be peeled from the roller 57.

It will therefore be appreciated that in this example, the web is peeled from the roller 57, whereas in the previous example, the web 2 is sheared from the holding member plate 7A. This can help ensure that the web remains in correct position when it is separated from the holding member 7, as well as reducing the stresses applied to the web 2 thereby helping to reduce deformation of the web.

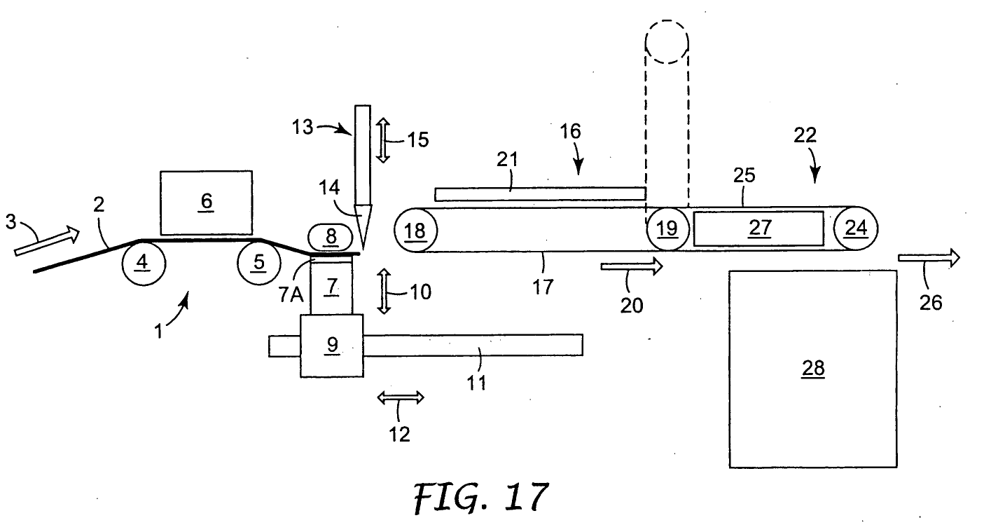

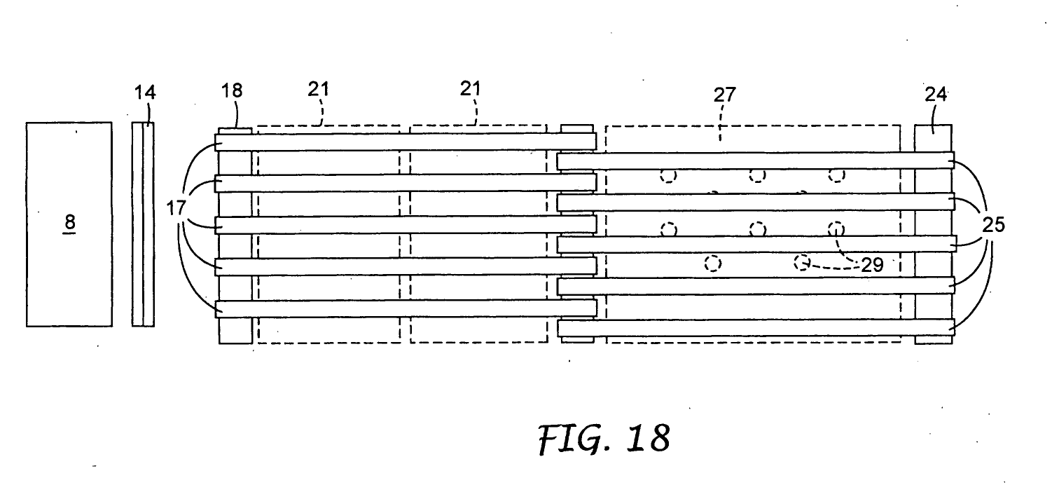

A second modification is shown in FIGS. 17 and 18. In this example, the applicator 22 is combined with the label transport 16. This can be achieved because the belts 17 and the belts 25 must usually be driven at the same speed. Accordingly, in this example, the belts 17, 25 are entrained around the roller 19 of the label transport 16, thereby obviating the need for the roller 23 normally provided in the applicator. This allows the belts to be driven by the common roller 19, thereby obviating the need for separate control of the label transport 16 and the applicator 22 by the drive motors.

As a result if this configuration is used, the belts 17, 25 must be vertically offset, as shown in FIG. 18, to allow the system to function correctly.

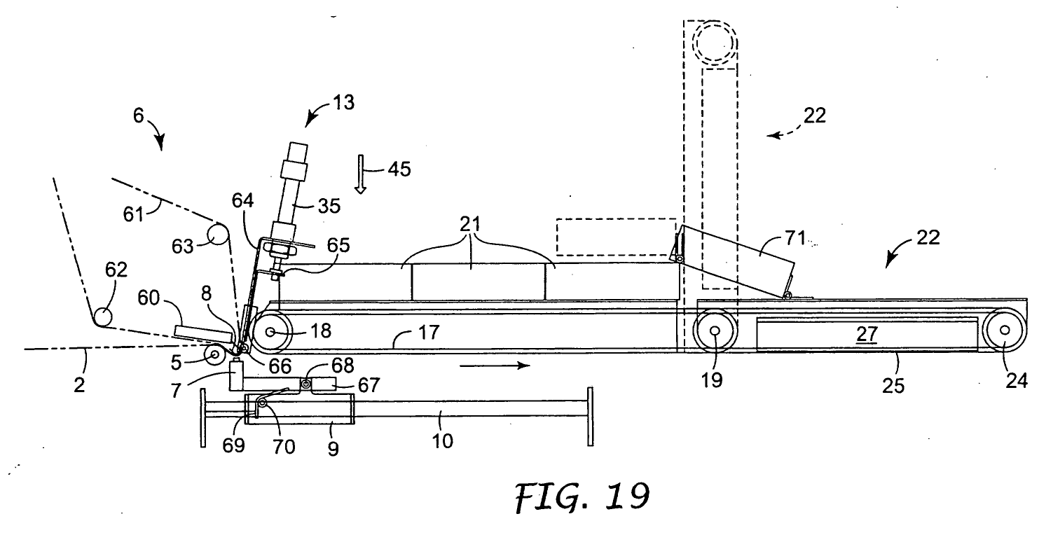

A specific example of the constructional arrangement of the system of FIG. 1 is shown in FIG. 19. In this diagram, similar reference numerals are used to indicate similar features to those shown in FIGS. 1 to 18.

As shown, the printing system 6 in this embodiment is formed from a thermal transfer printing system. Accordingly, the printing system 6 includes a print head 60 and a ribbon 61. In use, the ribbon 61 is entrained around a number of rollers, two of which are shown at 62, 62, as well as the print head 60 and the ski 8, as shown. As a result, the ribbon passes between the print head 60 and the non-adhesive side of the web 2.

In use, the print head will use a thermal element, to cause the ink to be transferred from the ribbon 61 to the web 2, to allow information including images and text to be transferred to the web. This process may result in the ribbon sticking weakly to the web 2. Accordingly, the ribbon is directed around the ski 8, as shown, to thereby separate the web 2 and the ribbon 61.

Accordingly, as shown, in this example, the ski 8 may be formed from a shaped piece of metal coupled to the print head 60, as shown. However, it will be appreciated that any suitable design of ski may be used.

In this example, the cutter 13 is formed from the actuator 35 which is coupled to two brackets 64, 65. In use, the bracket 64 holds the actuator 35 stationary, whilst the bracket 65 is adapted to move in the direction of the arrow 45, relative to the bracket 64. Positioned at the end of the bracket 65 is a heated wire, shown generally at 66.

In use, when the web 2 is to be cut, the actuator, which may be a solenoid actuator, or the like, is activated. This causes the bracket 65 to move in the direction of the arrow 45, thereby causing the wire to cut the web 2. It will be appreciated that the use of a heated wire helps improve the ease with which the web 2 is cut, thereby helping to ensure a clean cut is produced.

The moving member 7 is mounted to an arm 67 that is pivotally mounted to the carriage 9 at the pivot point 68, as shown. The arm 67 is also coupled to a lever 69, which is mounted to the carriage via a pivot point 70. The lever 69 is coupled to the arm 67 such that pivoting the lever 69 will cause corresponding pivoting of the arm 69 about the pivot point 68. In use, the actuator 34 is coupled to the lever 69, to allow the lever 69, the arm 67, and hence the holding member 7, to be moved as shown by the arrow 10 in FIG. 1.

Finally, a bracket 71 is shown coupled to the applicator 22. The bracket is coupled to the actuator 39, to allow the applicator 22 moved as described in more detail above. In this example, the label transport belts 17 and the applicator belts 25 are arranged around a common roller 19, and will therefore be arranged as shown in FIG. 18.

Operation of the embodiment shown in FIG. 19 will then be as described above with respect to the example of FIG. 1.

Persons skilled in the art will appreciate that numerous variations and modifications will become apparent. All such variations and modifications which become apparent to persons skilled in the art, should be considered to fall within the spirit and scope that the invention broadly appearing before described.

1. A device for creating adhesive labels from a web of material having an adhesive side and a non-adhesive side, the device including:
a) A web transport system for transporting the web from a web source along a web path to a web path end;
b) A label transport system for transporting a generated label along a label path;
c) A cutter positioned between the web path end and the label path, the cutter being adapted to cut the web to thereby generate the label;
d) A moveable holding member adapted to selectively hold the web by engaging the adhesive side of the web thereby causing the web to stick to the holding member in use; and,
e) A control system adapted to generate a label by:
i) Causing the holding member to:
(1) Engage the web provided at the web path end;
(2) Move from the web path end to the label path, thereby causing the web to extend from the web path to the label path;
(3) Release the web; and,
ii) Cause the cutter to cut the web extending from the web path end to the label path to generate the label.

2. A device according to claim 1, wherein once the web has been released, the control system is further adapted to:
1. Move from the label path to the web path end; and,
2. Hold the web provided at the web path end whilst the cutter cuts the web.

3. A device according to claim 1, the web transport being adapted to transport the web at a selected web speed.

4. A device according to claim 3, the label transport being adapted to transport the labels at a selected label speed.

5. A device according to claim 4, the control system being adapted to select the label speed and the web speed.

6. A device according to claim 5, the control system being adapted to:
a. Select a web speed of zero when the web is being cut, or when the holding member is urged against the web;
b. Select a label speed greater than zero when the web is being cut; and,
c. Select the label speed to be greater than the web speed.

7. A device according to claim 6, the control system being adapted to cause the holding member to:
a. Move at the selected web speed to move the web from the web path end to the label path; and,
b. Move at a speed greater than the selected web speed to release the web.

8. A device according to claim 7, the holding member being formed from a selectively rotatable roller, the control system being adapted to:
a. Prevent rotation of the roller when the web is being held and moved; and,
b. Allow rotation of the roller when the web is being released.

9. A device according to claim 3, the web transport being formed from a number of rollers around which the web is entrained in use, at least one of the rollers being coupled to a drive motor to allow the web to be driven at the selected web speed.

10. A device according to claim 4, the label transport including an endless belt system adapted to receive the non-adhesive side of the web.

11. A device according to claim 10, the endless belt system including a number of apertures extending therethrough, the label transport further including urging means for urging air through the apertures to thereby urge the label against the endless belt system.

12. A device according to claim 1, the device further including a printing system for printing information on the labels, the printing system being positioned on the web path.

13. A device according to claim 12, the printing system being a thermal printing system.

14. A device according to claim 1, the device being further including an applicator for applying the generated labels to an article in use.

15. A device according to claim 14, the applicator including an endless applicator belt system adapted to receive the non-adhesive side of the label in use, the endless belt system being movable to allow the adhesive side of the label to be urged against the article, in use.

16. A device according to claim 15, the applicator belt system further including a number of apertures extending therethrough, the applicator further including a vacuum pump coupled by a flow path to the apertures, the vacuum pump being adapted to generate a vacuum thereby urging the label against the endless belt system.

17. A device for creating adhesive labels from a web of material having an adhesive side and a non-adhesive side, the device being substantially as hereinbefore described.
